(19) United States
(12) Patent Application Publication
(10) Pub. No.: US 2005/0264022 A1
(43) Pub. Date: Dec. 1, 2005

(54) Vehicle sun visor apparatus

(75) Inventors: Hidetoshi Suzuki, Hamamatsu-shi (JP); Hiromi Suzuki, Kakegawa-shi (JP)

Correspondence Address: HAMRE, SCHUMANN, MUELLER & LARSON, P.C., P.O. BOX 2902-0902, MINNEAPOLIS, MN, 55402, US

(73) Assignee: ASMO CO., LTD., Kosai-shi (JP)

(21) Appl. No.: 11/141,368

(22) Filed: May 31, 2005

(30) Foreign Application Priority Data
May 31, 2004 (JP) 2004-160833

(51) Int. Cl. B60J 3/02

(52) U.S. Cl. 296/97.4

(57) ABSTRACT

A vehicle sun visor apparatus is located on a vehicle to block incident light on an eye position of an occupant of the vehicle. The vehicle sun visor apparatus includes a sun visor main body, a drive device, a light receiving sensor, a manipulation device, and a control device. The sun visor main body blocks the incident light, and the drive device moves the sun visor main body. The light receiving sensor is located at a position that does not block the view of the occupant and outputs a signal in accordance with the incident angle of the incident light. A range of an assumable eye position in the vehicle is set in advance, and the manipulation device inputs an assumed position of the eye position within the range by manipulation performed by the occupant. The control device specifies the incident angle of the incident light based on the output from the light receiving sensor and controls the movement of the sun visor main body by the drive device based on the incident angle and the assumed position.

### BACKGROUND OF THE INVENTION

The present invention relates to a vehicle sun visor apparatus that operates to automatically block incident light that enters a vehicle, for example, direct sunlight.

In the prior art, a sun visor apparatus is provided above a driver's seat and a front passenger seat of a vehicle to block incident light that enters the vehicle, for example, direct sunlight. The sun visor apparatus prevents dazzlement of an occupant due to incident light by blocking the incident light that shines on the eye position of the occupant, that is, the actual eye position of the occupant. Such a sun visor apparatus includes a sun visor main body attached inside the vehicle. The sun visor main body is generally moved manually to shield a predetermined area including the eye position of the occupant from light. However, the sun visor main body nowadays is automatically operated based on the eye position of an occupant, for example, a driver as disclosed in Japanese Laid-Open Patent Publication No. 7-329566 and Japanese National Phase Laid-Open Publication No. 8-509924.

A sun visor apparatus disclosed in the publication No. 7-329566 includes a case main body, and a sensor case is secured to the case main body such that the length is adjustable. The sensor case has first and second light receiving sensors, and the first light receiving sensor is located below the second light receiving sensor. The case main body accommodates a sun visor main body, which is selectively advanced and retracted, a drive mechanism, which drives the sun visor main body, and a motor that applies drive force to the drive mechanism. The sun visor apparatus includes a drive control circuit that controls actuation of the motor by output signals from the first and the second light receiving sensors.

Such a sun visor apparatus is attached above the driver's seat and the front passenger seat inside the vehicle. The occupant adjusts the height of the sensor case such that the second light receiving sensor is located at the eye level of the occupant. When both the first and the second light receiving sensors detect light, the drive control circuit advances the sun visor main body by driving the motor forward such that the second light receiving sensor does not detect light. In a state where the sun visor main body is advanced, if both the first and the second light receiving sensor do not detect light, the drive control circuit retracts the sun visor main body by driving the motor in reverse. If the first light receiving sensor detects light, the drive control circuit stops the motor so that the sun visor main body is stopped.

A sun visor apparatus disclosed in Japanese National Phase Laid-Open Publication No. 8-509924 specifies a first straight line that connects the eye position and the sun and a second straight line that connects the eye position and a light source other than the sun to move the sun visor main body to a position for blocking light. For example, the first straight line is specified based on the information of a point on the ray of the sun and the second straight line is specified based on the information of any point in space. Then, the sun visor apparatus moves the sun visor main body to hide the intersection between the first and the second straight lines from the light source. The intersection between the first and the second straight lines and the moving amount of the sun visor are calculated by a control device provided in the sun visor apparatus.

Japanese National Phase Laid-Open Publication No. 8-509924 also discloses a method for simplifying the computation of the control device by directly specifying the eye position using, for example, a device that generates and receives a sound wave or an electromagnetic wave.

However, according to the sun visor apparatus disclosed in the publication No. 7-329566, since the position of the sensor case is adjusted such that the second light receiving sensor is located at the eye level of the occupant, the front view of the occupant view may be blocked by the sensor case.

Since the eye position and the moving amount of the sun visor main body must be computed every time according to the sun visor apparatus of Japanese National Phase Laid-Open Publication No. 8-509924, the sun visor apparatus has a problem that a load is applied to the control device due to a large amount of the computation processes. Furthermore, although a device that generates and receives a sound wave or an electromagnetic wave has been proposed, the configuration of the sun visor apparatus equipped with such a device is complicated.

### SUMMARY OF THE INVENTION

Accordingly, it is an objective of the present invention to provide a vehicle sun visor apparatus that prevents the configuration from becoming complicated while securing a good view and performs an appropriate light blocking control for an individual occupant through a simple computation process.

To achieve the foregoing and other objectives and in accordance with the purpose of the present invention, a vehicle sun visor apparatus for blocking incident light on an eye position of an occupant of a vehicle is provided. The apparatus includes a sun visor main body, a drive device, a light receiving sensor, a manipulation device, and a control device. The sun visor main body is movably supported by the vehicle to block the incident light. The drive device moves the sun visor main body. The light receiving sensor is located at a position that does not block the view of the occupant. The light receiving sensor outputs a signal in accordance with the incident light. A range of an assumable eye position in the vehicle is set in advance, and the manipulation device inputs an assumed position of the eye position within the range by manipulation performed by the occupant. The control device specifies the incident angle of the incident light based on the output from the light receiving sensor. The control device controls the movement of the sun visor main body by the drive device based on the incident angle and the assumed position.

The present invention provides another vehicle sun visor apparatus for blocking incident light on an eye position of an occupant of a vehicle. The vehicle includes a driver's seat and a front passenger seat. The apparatus includes a first sun visor main body, a second sun visor main body, a first drive device, a second drive device, a light receiving sensor, a manipulation device, and a control device. The first sun visor main body movably is supported by the vehicle to block the incident light on the eye position of the occupant seated in the driver's seat. The second sun visor main body movably is supported by the vehicle to block the incident light on the eye position of the occupant seated in the front passenger seat. The first drive device moves the first sun visor main body. The second drive device moves the second sun visor main body. The light receiving sensor is located at a position that does not block the view of the occupant. The light receiving sensor outputs a signal in accordance with the incident light. A range of an assumable eye position in the vehicle is set in advance. The manipulation device inputs a first assumed position of the eye position of the occupant seated in the driver's seat and a second assumed position of the eye position of the occupant seated in the front passenger seat within the range by manipulation performed by the occupant. The control device specifies the incident angle of the incident light based on the output from the light receiving sensor. The control device controls the movement of the first and the second sun visor main bodies by the drive devices based on the incident angle and the first and second assumed positions. The manipulation device includes a manipulation body and a selector switch. The manipulation body is manipulated by the occupant. The selector switch selects either the movement of the first assumed position or the movement of the second assumed position. The manipulation device is located between the driver's seat and the front passenger seat.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating a vehicle sun visor apparatus according to a first embodiment;

FIG. 2 is a block diagram illustrating the configuration of the vehicle sun visor apparatus;

FIG. 3(a) is a diagram illustrating a measuring area in the width direction of the vehicle;

FIG. 3(b) is a diagram illustrating a measuring area in the vertical direction of the vehicle;

FIG. 4 is a diagram illustrating the eye position of an average sized person;

FIG. 5(a) is a front view illustrating a manipulation device;

FIG. 5(b) is a conceptual diagram illustrating a select range of the eye position;

FIG. 6(a) is a front view illustrating a manipulation device according to a second embodiment;

FIG. 6(b) is a conceptual diagram illustrating the range of the eye position;

FIG. 7(a) is a front view illustrating a manipulation device according to a third embodiment;

FIG. 7(b) is a conceptual diagram illustrating the range of the eye position;

FIG. 8 is a conceptual diagram illustrating a select range of the eye position according to a first modified embodiment;

FIG. 9 is a conceptual diagram illustrating the range of the eye position according to a second modified embodiment;

FIG. 10 is a front view illustrating a manipulation device according to a third modified embodiment;

FIG. 11 is a front view illustrating a manipulation device according to a fourth modified embodiment;

FIG. 12(a) is a side view illustrating a manipulation device according to a fifth modified embodiment;

FIG. 12(b) is a front view illustrating the manipulation device according to the fifth modified embodiment;

FIG. 13 is a perspective view illustrating a door of a vehicle on which a manipulation device according to a sixth modified embodiment is arranged;

FIG. 14 is a conceptual diagram illustrating a manipulation device according to the sixth modified embodiment;

FIG. 15 is a front view illustrating a manipulation device according to a seventh modified embodiment;

FIG. 16 is a perspective view illustrating a manipulation device according to an eighth modified embodiment;

FIG. 17 is a perspective view illustrating a manipulation device according to a ninth modified embodiment;

FIG. 18(a) is a front view illustrating a manipulation device according to a tenth modified embodiment;

FIG. 18(b) is a perspective view illustrating the manipulation device according to the tenth modified embodiment;

FIG. 19 is a perspective view illustrating a manipulation device according to an eleventh modified embodiment;

FIG. 20 is a conceptual diagram illustrating a securing position of a manipulation device according to a twelfth modified embodiment;

FIG. 21 is a plan view illustrating the manipulation device according to the twelfth modified embodiment;

FIG. 22 is a conceptual diagram explaining a method of a light blocking control according to a thirteenth modified embodiment;

FIG. 23 is a front view illustrating a manipulation input device according to a fourteenth modified embodiment; and

FIG. 24 is a block diagram illustrating the configuration of a vehicle sun visor apparatus according to the fourteenth modified embodiment.

### DETAILED DESCRIPTION OF THE PREFERRED EMBODIMENTS

### First Embodiment

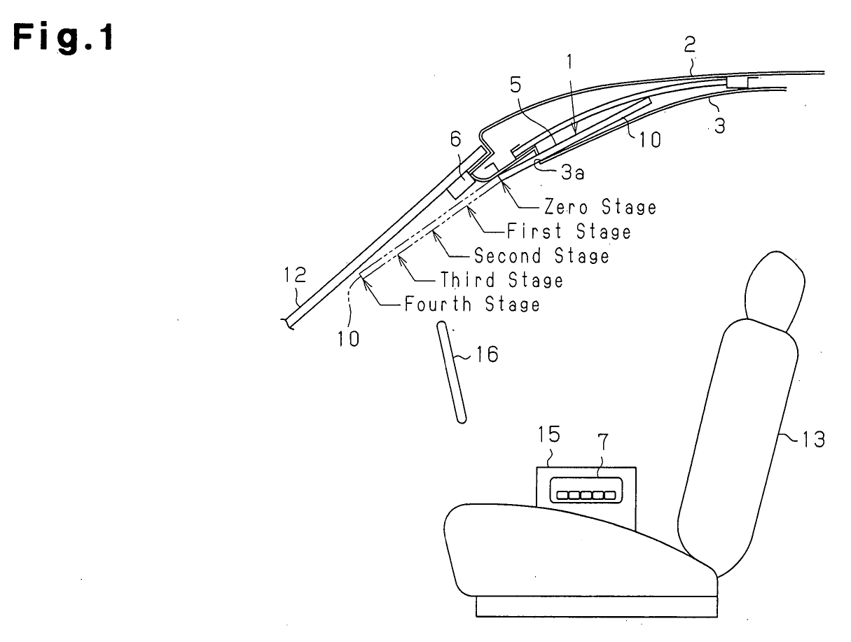

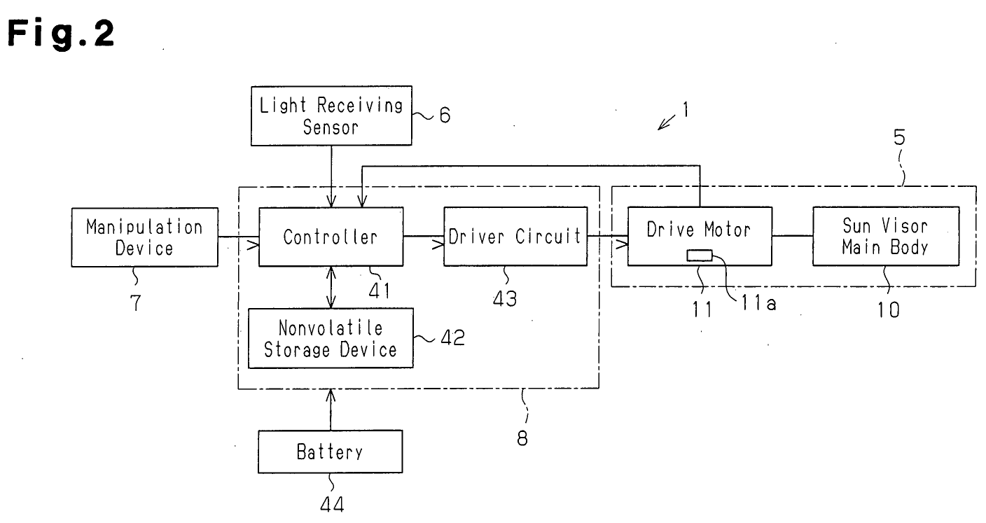

A vehicle sun visor apparatus 1 according to a first embodiment of the present invention will now be described with reference to the drawings. FIG. 1 shows the vehicle sun visor apparatus 1 according to the first embodiment. The vehicle sun visor apparatus 1 is arranged on a ceiling 3 of a vehicle 2, and includes a light blocking device 5, a light receiving sensor 6, a manipulation device 7, and a control device 8 (see FIG. 2).

The light blocking device 5 is accommodated in the ceiling 3. The light blocking device 5 includes a sun visor main body 10, a drive mechanism, which is not shown, and a drive device, which is a drive motor 11 in the first embodiment (see FIG. 2). The sun visor main body 10 is rectangular and formed with an opaque member to block incident light. An opening portion 3a is formed at the front end portion of the ceiling 3. When the drive motor 11 is actuated, the sun visor main body 10 advances from the opening portion 3a or retracts to be stored in the ceiling 3 via the drive mechanism in accordance with the drive direction of the drive motor 11. The amount of advancement of the sun visor main body 10 from the opening portion 3a is divided into some stages from a stored state where the sun visor main body 10 is stored in the ceiling 3 to a state where the sun visor main body 10 is advanced to the maximum in the vehicle 2. In the first embodiment, the amount of advancement of the sun visor main body 10 in the stored state is referred to as a zero stage. Furthermore, the length of the sun visor main body 10 along the advancing direction in a state where the sun visor main body 10 is advanced to the maximum is divided into four. The amount of advancement of the sun visor main body 10 in a state where the sun visor main body 10 is advanced to a position corresponding to each division from the opening portion 3a is sequentially set to first to fourth stages. Therefore, the amount of advancement of the sun visor main body 10 according to the first embodiment is set to five stages as a whole. When the sun visor main body 10 is advanced to the maximum, the sun visor main body 10 covers a predetermined range above the middle of a windshield 12 in front of the driver's seat.

As shown in FIG. 2, the drive motor 11 includes a rotation detecting device 11a, which is integrally formed with the drive motor 11. The rotation detecting device 11a outputs a pulse signal that is in synchronization with rotation of the drive motor 11 to the control device 8. The rotation detecting device 11a has, for example, two hall elements each of which outputs a pulse signal that is in synchronization with the rotation of the drive motor 11. The pulse signals output from the hall elements have a predetermined phase difference. The control device 8 detects the rotation direction of the drive motor 11 based on the phase difference of the pulse signals. Furthermore, the control device 8 counts the number of pulses based on the edge of the pulse signal and detects the position. of the sun visor main body 10 based on the count value.

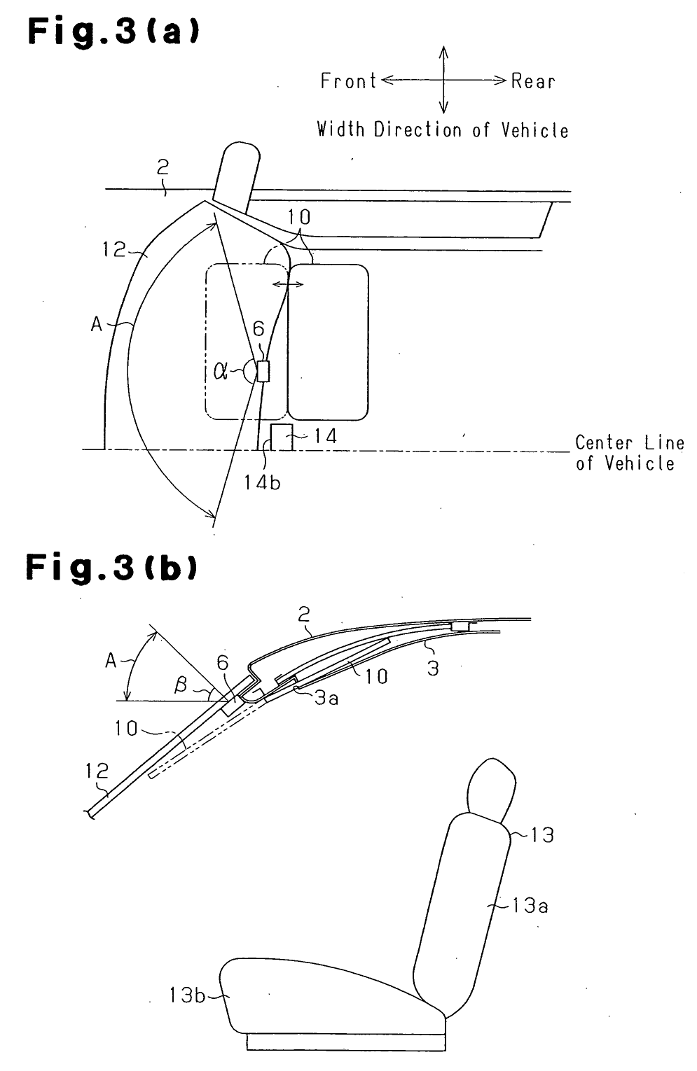

As shown in FIG. 1, the light receiving sensor 6 is secured to the vehicle at a position where the incident light is not blocked by, for example, the ceiling 3, that is, where the light receiving sensor 6 can always detect the incident light and the light receiving sensor 6 does not block the view of the occupant. More specifically, the light receiving sensor 6 is located on the inner surface of the upper end of the windshield 12 and substantially in front of a seat 13 in which the occupant is seated. As shown in FIG. 3(a), the light receiving sensor 6 is located at a position upper than a lower end 14b of a rearview mirror 14 and forward of the rearview mirror 14.

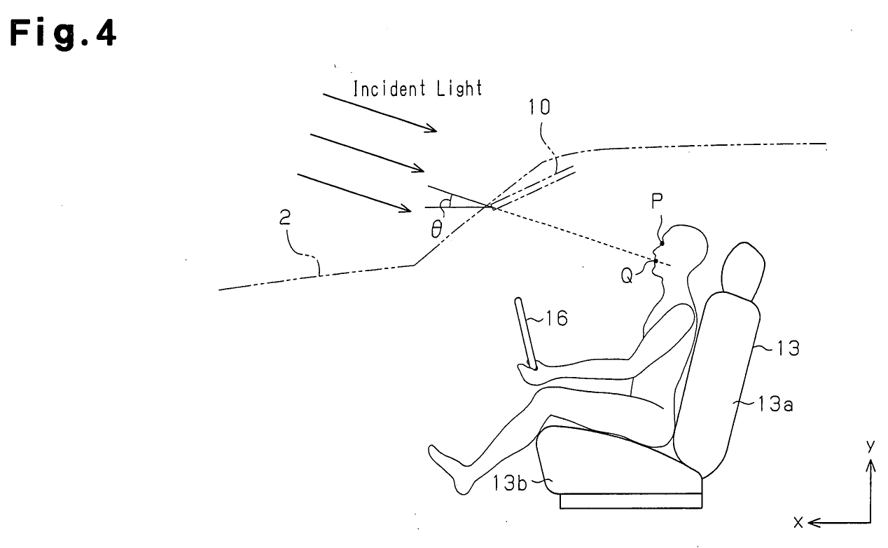

The light receiving sensor 6 includes light receiving elements, which are not shown, and detects the intensity of the incident light that enters the measuring area A, the incident angle θ (see FIG. 4) of the incident light in the vertical direction, and the incident angle in the width direction as shown in FIGS. 3(a) and 3(b). The measuring area A is set to a minimum range that needs to be shielded from light to prevent dazzlement of the occupant when the occupant is seated in the seat 13 in an appropriate posture. More specifically, the measuring area A in the width direction has a sectorial shape represented by the central angle α as shown in FIG. 3(a), and the measuring area A in the vertical direction has a sectorial shape represented by the central angle β as shown in FIG. 3(b). When incident light enters the measuring area A, the light receiving sensor 6 outputs signals corresponding to the intensity of the incident light, the incident angle θ in the vertical direction (see FIG. 4), and the incident angle in the width direction to the control device 8.

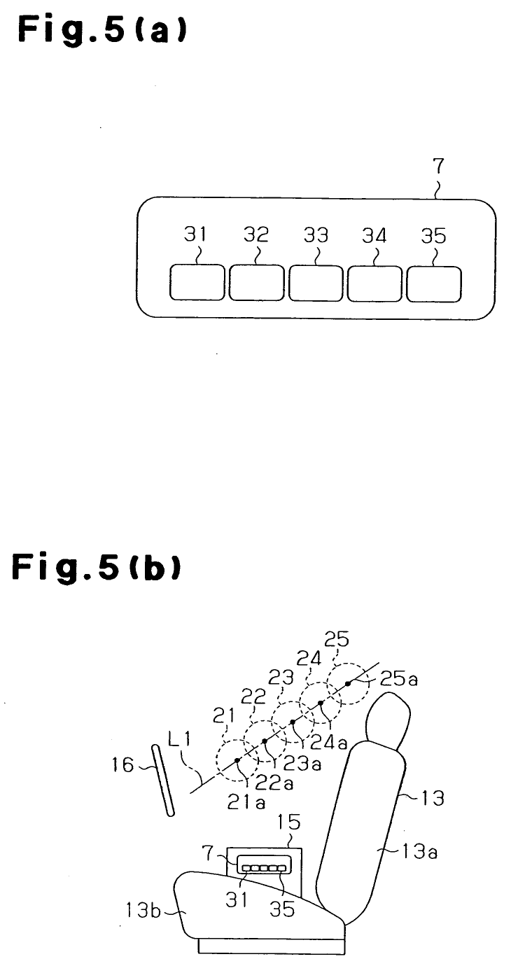

As shown in FIGS. 5(a) and 5(b), the manipulation device 7 is secured to a side box 15 provided on the door located adjacent to the side of the driver's seat, and is used when setting the eye position of the occupant. The eye position P of the occupant (see FIG. 4) generally depends on the physical size of the occupant. More specifically, a short person has short arms and legs, and is seated with the seat moved forward of the vehicle 2. Therefore, the eye position P of the short person is located towards the front of the vehicle 2. A tall person has long arms and legs, and is seated with the seat moved rearward of the vehicle 2. Therefore, the eye position P of the tall person is located toward the rear of the vehicle 2. The eye position P of a person having a short sitting height is relatively low, and the eye position P of a person having a high sitting height is relatively high. Therefore, most of eye positions P of occupants are located in a range between a steering wheel 16 and a seat back 13a of the seat 13 in a state where the seat 13 is moved to the rearmost position and reclined to the maximum, and between the ceiling 3 and a seat cushion 13b of the seat 13. Based on such a distribution of the eye positions P, select positions 21a to 25a of five eye positions P corresponding to the eye positions P of the occupants having different physical sizes and an assumed position that is the assumption of the eye position P of the occupant who needs to be shielded from light are set in the control device 8 in advance. The assumed position is used as a reference during the light blocking control and is selected from the select positions 21a to 25a.

As shown in FIG. 5(b), the select positions 21a to 25a are set along a straight line L1 that inclines upward from the front of the vehicle 2 toward the rear of the vehicle 2 at equal intervals. This is because, in general, the sitting height of a tall person is high and the sitting height of a short person is short. The select positions 21a to 25a each have circular select ranges 21 to 25 of the eye position P about the select positions 21a to 25a, respectively. The select ranges 21 to 25 are set to include the eye position P of an occupant who has the physical size that is slightly different from any of the occupants to whom the select positions 21a to 25a correspond within the ranges of the select ranges 21 to 25. The size of the circle forming each select range 21 to 25 is set to a size such that the adjacent circles overlap each other. The select ranges 21 to 25 are set in the control device 8 in advance like the select positions 21a to 25a and the assumed position.

As shown in FIG. 5(a), the manipulation device 7 includes manipulation bodies, which are five switches 31 to 35. The switches 31 to 35 are arranged along the fore-and-aft direction of the vehicle, and the switches 31 to 35 correspond to the select ranges 21 to 25 (select positions 21a to 25a ) in order from those at the front. More specifically, the switch 31 at the forefront position corresponds to the select range 21 at the forefront position, and the switches 32, 33, 34, 35 located behind the switch 31 sequentially correspond to the select ranges 22, 23, 24, 25 located behind the select range 21.

As shown in FIG. 2, the control device 8 includes a controller 41, a nonvolatile storage device 42, and a driver circuit 43, and is supplied with a drive power source from a battery 44. The controller 41 includes five control maps, which are not shown, corresponding to the select ranges 21 to 25, and performs the light blocking control in accordance with the maps. The amount of advancement of the sun visor main body 10 corresponding to the incident angle θ of the incident light is defined in the control maps based on the select ranges 21 to 25. That is, the amount of advancement of the sun visor main body 10 for preventing the incident light from shining on the selected one of the select ranges 21 to 25 is defined in the control map in accordance with the incident angle θ of the incident light.

The controller 41 is electrically connected to the manipulation device 7. The controller 41 detects a manipulation signal from the switches 31 to 35 and determines which of the select ranges 21 to 25 (select positions 21a to 25a) is selected based on the manipulation signal. Then, the controller 41 selects one of the select ranges 21 to 25 (select positions 21a to 25a) corresponding to the manipulated one of the switches 31 to 35. For example, when the occupant selects the switch 31, a manipulation signal corresponding to the switch 31 is output to the control device 8. The controller 41 then selects the select range 21 (select position 21a) corresponding to the switch 31. In other words, when the occupant manipulates any of the switches 31 to 35 of the manipulation device 7, the controller 41 specifies the assumed position among the select positions 21a to 25a. Then, the controller 41 performs the light blocking control based on the selected one of the select ranges 21 to 25, that is, the assumed position specified among the predetermined select positions 21a to 25a and the signal of the incident light output from the light receiving sensor 6. More specifically, the controller 41 detects the incident angle θ of the incident light through computation based on the signal output from the light receiving sensor 6. Also, the controller 41 detects the incident intensity of the incident light that enters the measuring area A based on the signal output from the light receiving sensor 6. Then, if the incident intensity of the incident light is greater than or equal to a predetermined intensity, the controller 41 performs the light blocking control in accordance with the incident angle θ of the incident light and the control map corresponding to the selected one of the select ranges 21 to 25.

The nonvolatile storage device 42 stores the selected one of the select ranges 21 to 25 (select positions 21a to 25a). The driver circuit 43 supplies, based on a control signal output from the controller 41, a drive current in a direction corresponding to the control signal to the drive motor 11. The drive motor 11 is rotated forward or in reverse corresponding to the direction of the drive current, and the rotation of the drive motor 11causes the sun visor main body 10 to advance or retract.

The operations of the vehicle sun visor apparatus 1 configured as described above will now be described. When an ignition switch (not shown) of the vehicle 2 is switched on, a power switch (not shown) of the vehicle sun visor apparatus 1 is switched on. When the vehicle sun visor apparatus 1 is used for the first time, the switch 31 of the manipulation device 7 is selected.

When the switch 31 is selected, the controller 41 causes the sun visor main body 10 to selectively advance and retract in accordance with the. incident angle θ of the incident light to prevent the incident light from shining on the select range 21 based on the control map corresponding to the select range 21.

If the light blocking control corresponding to the select range 21 selected by the switch 31 is not appropriate, the occupant selects any of the select ranges 22 to 25 (select positions 21a to 25a) via the corresponding one of the switches 32 to 35 of the manipulation device 7. Based on the control map corresponding to the selected one of the select ranges 22 to 25, the controller 41 causes the sun visor main body 10 to selectively advance and retract in accordance with incident angle θ of the incident light, and prevents the incident light from shining on the selected one of the select ranges 22 to 25.

The selected one of the select ranges 21 to 25 (select positions 21a to 25a) is stored in the nonvolatile storage device 42 by the controller 41 when one of the switches 31 to 35 is selected. When the vehicle sun visor apparatus 1 is used again, the controller 41 performs the light blocking control in accordance with one of the select ranges 21 to 25 (select positions 21a to 25a) stored in the nonvolatile storage device 42. Therefore, in a case the vehicle sun visor apparatus 1 is used by the same occupant continually, the occupant does not need to select one of the select ranges 21 to 25 by manipulating the corresponding one of the switches 31 to 35 every time the occupant is seated in the seat 13. In addition, since the controlled variable of the controller 41 is reduced as compared to a case where one of the select ranges 21 to 25 is selected every time the vehicle sun visor apparatus 1 is used, the load on the controller 41 is reduced.

As described above, the first embodiment has the following advantages.

(1) The occupant manipulates.any of the switches 31 to 35 of the manipulation device 7 to select one of the select ranges 21 to 25 that includes the eye position P of the occupant. Based on the selected one of the select ranges 21 to 25 and the incident angle θ of the incident light detected by the light receiving sensor 6, the controller 41 performs the light blocking control. Therefore, the switches 31 to 35 41 performs the light blocking control appropriate for the individual occupant. Also, since the occupant selects one of the select ranges 21 to 25, and the light blocking control is performed based on the selected one of the select ranges 21 to 25; the controller 41 does not need to perform the computation to obtain the eye position P of the occupant. Therefore, the controller 41 only needs to determine the amount of advancement of the sun visor main body 10 in accordance with the incident angle θ of the incident light based on the control map. Thus, the controller 41 performs the light blocking control through a simple computation process.

(2) Since the light receiving sensor 6 is secured to a position that does not block the view of the occupant, the occupant obtains a good view.

(3) Since a device that utilizes a sound wave or an electromagnetic wave is not used to obtain the eye position P, the configuration of the vehicle sun visor apparatus 1 is prevented from being complicated.

(4) The manipulation device 7 is secured to the side box 15 on the door adjacent to the seat 13 in which the occupant is seated. Therefore, the occupant can easily reach the manipulation device 7 with the hand, and easily manipulates the manipulation device 7.

(5) Since the select ranges 21 to 25 are determined in advance, the controller 41 only needs to determine the amount of advancement of the sun visor main body 10 in accordance with one of the control maps that corresponds to the selected one of the select range 21 to 25. Therefore, the controller 41 performs the light blocking control through a simple computation process.

(6) The select positions 21a to 25a are defined along the straight line L1 corresponding to the physical sizes of various occupants. Therefore, the controller 41 performs the light blocking control corresponding to the occupants with various physical sizes. Furthermore, since the select positions 21a to 25a have the select ranges 21 to 25, the controller 41 performs the light blocking control appropriate for an occupant who has the physical size that is slightly different from any of the occupants to whom the select positions 21a to 25a correspond.

### Second Embodiment

A second embodiment of present invention will now be described with reference to the drawings. In the second embodiment, like or the same reference numerals are given to those components that are like or the same as the corresponding components of the first embodiment and detailed explanations are omitted.

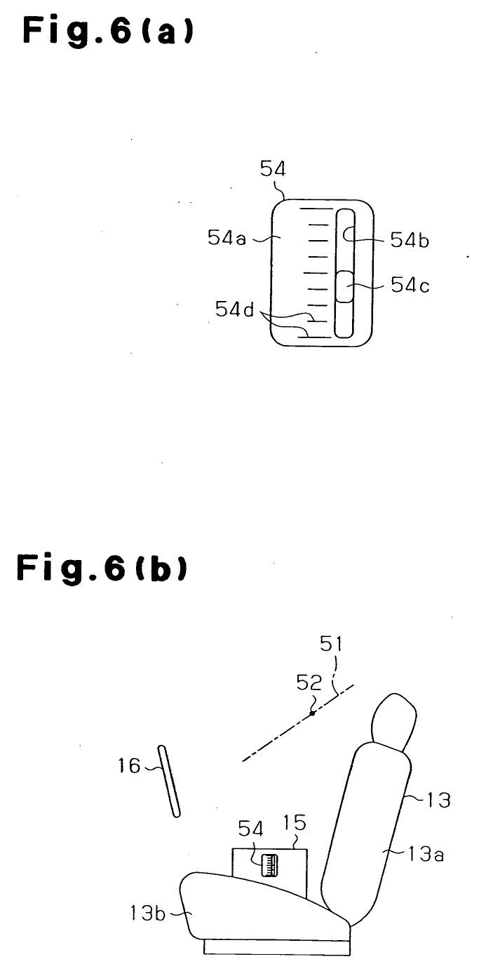

As shown in FIG. 6(b), in the second embodiment, a range 51 of the eye position P that permits movement of the assumed position 52 is set based on the distribution of the eye position P. The range 51 of the eye position P is set along a straight line that inclines upward from the front of the vehicle 2 to the rear of the vehicle 2, and is set in advance by the control device 8. This is because, in general, the sitting height of a tall person is high and the sitting height of a short person is short. As shown in FIGS. 6(a) and 6 (b), the vehicle sun visor apparatus 1 of the second embodiment includes a manipulation device 54. The manipulation device 54 moves an assumed position 52 within the range 51 of the eye position P. The manipulation device 54 includes a rectangular panel 54a and a manipulation body, which is a slide switch 54c in the second embodiment. A groove 54b is formed on the panel 54a along the longitudinal direction of the panel 54a. A scale 54d, which equally divides the longitudinal length of the groove 54b, is formed on the outer surface of the panel 54a. The slide switch 54c is arranged in the groove 54b to be slidable along the longitudinal direction of the groove 54b. The manipulation device 54 is secured to the outer surface of the side box 15 on the door adjacent to the side of the driver's seat such that the groove 54b extends in the vertical direction.

The moving range of the slide switch 54c corresponds to the length of the range 51 of the eye position P. More specifically, when the slide switch 54c is located at the lowermost end of the groove 54b, the assumed position 52 is located at the lowermost end of the range 51 of the eye position P, and when the slide switch 54c is located at the uppermost end of the groove 54b, the assumed position 52 is located at the uppermost end of the range 51 of the eye position P. When the slide switch 54c slides from the lowermost end of the groove 54b to the uppermost end of the groove 54b, the assumed position 52 moves from the lowermost end to the uppermost end in the range 51 of the eye position P.

The manipulation device 54 is electrically connected to the controller 41. The manipulation device 54 is a variable resistor, and the resistance value of the variable resistor increases as, for example, the slide switch 54c moves upward. Therefore, the controller 41 detects the assumed position 52 by detecting the voltage corresponding to the resistance value that is changed as the slide switch 54c is slid.

The operation of the vehicle sun visor apparatus 1 according to the second embodiment will now be described. Differences from the vehicle sun visor apparatus 1 of the first embodiment will mainly discussed below. When the occupant feels the light blocking control is not appropriate, the occupant slides the slide switch 54c of the manipulation device 54 to move the assumed position 52 such that the assumed position 52 is located closest to the occupant's eye position P. For example, if the amount of advancement of the sun visor main body 10 is excessive, the assumed position 52 is likely to be located lower than the eye position P of the occupant. Therefore, the occupant slides the slide switch 54c upward to move the assumed position 52 upward within the range 51 of the eye position P. Contrarily, if the amount of advancement of the sun visor main body 10 is insufficient, the assumed position 52 is likely to be located upper than the eye position P of the occupant. Therefore, the occupant slides the slide switch 54c downward to move the assumed position 52 downward within the range 51 of the eye position P. At this time, the occupant preferably manipulates the slide switch 54c using the scale 54 d on the panel 54a as a target.

When the slide switch 54c is manipulated, the controller 41 detects the voltage corresponding to the change of the resistance value of the manipulation device 7, and detects the assumed position 52 of the eye position P in the range 51. Then, the controller 41 performs the light blocking control based on the detected assumed position 52 and the signal output from the light receiving sensor 6. That is, the controller 41 performs the light blocking control based on the assumed position 52 determined by the occupant and a control map computed in accordance with the incident angle θ of the incident light.

The amount of advancement of the sun visor main body 10 corresponding to the incident angle θ of the incident light is set in the control map based on the assumed position 52 in the range 51 of the eye position P. When the assumed position 52 is moved by the slide switch 54c, the controller 41 reads the data of the amount of advancement of the sun visor main body 10 corresponding to the incident angle θ at that time from the control map, and blocks light by relatively changing the amount of advancement of the sun visor main body 10 in accordance with the moved assumed position 52.

The assumed position 52 after being moved is stored in the nonvolatile storage device 42 by the controller 41. When the vehicle sun visor apparatus 1 is used again, the controller 41 performs the light blocking control in accordance with the assumed position 52 stored in the nonvolatile storage device 42. Therefore, when the vehicle sun visor apparatus 1 is used by the same occupant continually, the occupant does not need to manipulate the slide switch 54c to make the assumed position 52 correspond to the occupant's eye position P every time the occupant is seated in the seat 13. In addition, when the vehicle sun visor apparatus 1 is used, since the control variable of the controller 41 is reduced as compared to a case where the assumed position 52 is moved every time, the load on the controller 41 is reduced.

As described above, the second embodiment provides the following advantages in addition to the advantages (2) to (4) of the first embodiment.

(7) The occupant manipulates the slide switch 54c of the manipulation device 7 to move the assumed position 52 to a position closest to the eye position P of the occupant. Then, the controller 41 performs the light blocking control based on the assumed position 52 and the incident angle θ of the incident light detected by the light receiving sensor 6. Therefore, the controller 41 performs the light blocking control appropriate for the individual occupant. Also, since the occupant determines the position of the assumed position 52, the controller 41 does not need to perform computation for obtaining the eye position P. Therefore, the controller 41 only needs to determine the amount of advancement of the sun visor main body 10 in accordance with the incident angle θ of the incident light, and the light blocking control is performed through a simple computation process.

(8) The assumed position 52 is moved upward when the slide switch 54c is slid upward, and is moved downward when the slide switch 54c is slid downward. Therefore, the occupant can easily grasp a direction along which the assumed position 52 is moved, and can easily manipulate the manipulation device 54. As a result, the occupant can easily make the assumed position 52 correspond to the eye position P of the occupant.

(9) Since the range 51 is defined by a one-dimensional straight line, the occupant can easily adjust the assumed position 52 as compared to a case where the range 51 is defined by a two-dimensional representation. In addition, the assumed position 52 moves continuously within the range 51 of the eye position P. Therefore, as compared to a case where the select positions 21a to 25a, which specify the assumed positions, are set discontinuously as in the first embodiment, the occupant can adjust the assumed position 52 more finely. As a result, the assumed position 52 can be moved to a position close to the eye position P of the occupant. Furthermore, the assumed position 52 only moves within the range 51 of the eye position P on the straight line, the control for moving the assumed position is simple. Therefore, the control variable of the controller 41 is reduced, which reduces the load on the controller 41.

(10) The range 51 is located on the straight line that inclines upward from the front of the vehicle 2 to the rear of the vehicle 2. Therefore, the assumed position 52 is set to positions corresponding to the eye positions P of more occupants. Thus, the controller 41 performs the light blocking control appropriate for the individual occupant.

### Third Embodiment

A third embodiment of the present invention will now be described with reference to the drawings. In the third embodiment, like or the same reference numerals are given to those components that are like or the same as the corresponding components of the first and second embodiments and detailed explanations are omitted.

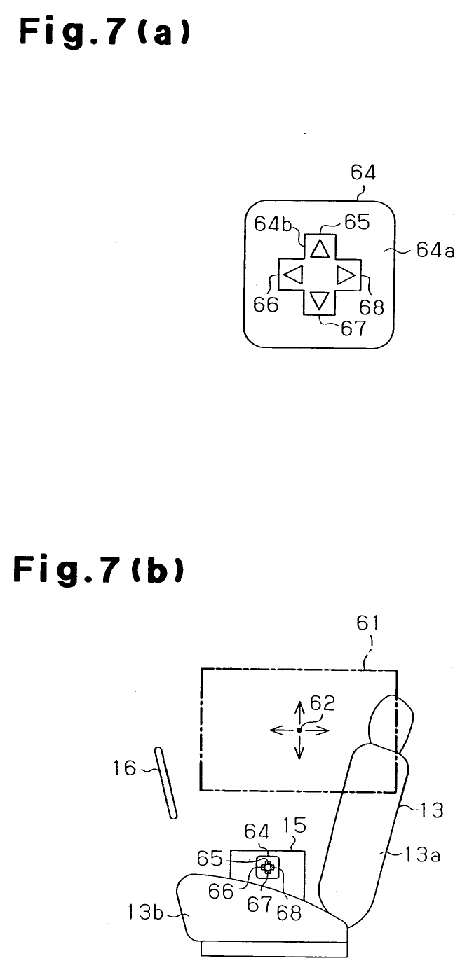

As shown in FIG. 7(b), a range 61 of the eye position P according to the third embodiment is set between the steering wheel 16 and the seat back 13a of the seat 13 in a state where the seat 13 is moved to the rearmost position and is reclined to the maximum, and between the ceiling 3 and the seat cushion 13b of the seat 13. The range 61 is set on a rectangle extending in the vertical and the fore-and-aft directions of the vehicle 2. In FIG. 7(b), the seat 13 can further be moved rearward and the seat back 13a can further be reclined rearward.

As shown in FIGS. 7(a) and 7(b), the vehicle sun visor apparatus 1 of the third embodiment includes a manipulation device 64. The manipulation device 64 moves an assumed position 62 within the range 61 of the eye position P. The manipulation device 64 includes a substantially square panel 64a. A manipulation body, which is a cross key 64b is located at the center of the panel 64a. The cross key 64b includes four key portions 65 to 68, which are integrally formed. The manipulation device 64 is secured to the outer side surface of the side box 15 on the door adjacent to the side of the driver's seat. The four key portions 65 to 68 correspond to the vertical direction and the fore-and-aft direction of the vehicle 2. That is, the manipulation direction of the cross key 64b corresponds to the moving direction of the assumed position 62.

The manipulation device 64 is electrically connected to the controller 41, and outputs a manipulation signal to the controller 41 when any of the key portions 65 to 68 is pressed by the occupant. The controller 41 moves the assumed position 62 within the range 61 of the eye position P along a direction based on the manipulation signal, that is, along a direction indicated by the pressed one of the key portions 65 to 68. While one of the key portions 65 to 68 is pressed by the occupant and the manipulation signal is output from the manipulation device 64, the assumed position 62 moves along a direction indicated by the pressed one of the key portions 65 to 68. The assumed position 62 is stopped when the occupant releases the key portions 65 to 68.

The operations of the vehicle sun visor apparatus 1 according to the third embodiment will now be described. Differences from the vehicle sun visor apparatus 1 of the first and second embodiments will mainly discussed below. When the occupant feels that the light blocking control is not appropriate, the occupant manipulates the key portions 65 to 68 of the manipulation device 64 to move the assumed position 62 such that the assumed position 62 matches with the occupant's eye position P. At this time, the controller 41 moves the assumed position 52 based on the manipulation signal input by the manipulation of the key portions 65 to 68. Then, the controller 41 performs the light blocking control based on the moved assumed position 62 and the signal output from the light receiving sensor 6. That is, the controller 41 performs the light blocking control based on the assumed position 62 determined by the occupant and a control map computed in accordance with the incident angle θ of the incident light.

The amount of advancement of the sun visor main body 10 corresponding to the incident angle θ of the incident light is set in the control map based on the assumed position 62 within the range 61 of the eye position P. When the assumed position 62 is moved by the cross key 64b, the controller 41 reads data of the amount of advancement of the sun visor main body 10 corresponding to the incident angle θ at that time from the control map, and blocks light by relatively changing the amount of advancement of the sun visor main body 10 in accordance with the moved assumed position 62.

The assumed position 62 after being moved is stored in the nonvolatile storage device 42 by the controller 41. When the vehicle sun visor apparatus 1 is used again, the controller 41 performs the light blocking control in accordance with the assumed position 62 stored in the nonvolatile storage device 42. Therefore, when the vehicle sun visor apparatus 1 is used by the same occupant continually, the occupant does not need to manipulate the cross key 64b to make the assumed position 62 correspond to the occupant's eye position P every time the occupant is seated in the seat 13. In addition, when the vehicle sun visor apparatus 1 is used, since the control variable of the controller 41 is reduced as compared to a case where the assumed position 62 is moved every time, the load on the controller 41 is reduced.

As described above, the third embodiment provides the following advantages in addition to the advantages (2) to (4) of the first embodiment.

(11) The occupant manipulates the cross key 64b of the manipulation device 64 to match the assumed position 62 with the eye position P of the occupant. Then, based on the assumed position 62 and the incident angle θ of the incident light detected by the light receiving sensor 6, the controller 41 performs the light blocking control. Therefore, the controller 41 performs the light blocking control appropriate for the individual occupant. Also, since the occupant determines the assumed position 62, the controller 41 does not need to perform computation for obtaining the eye position P. Therefore, the controller 41 only needs to determine the amount of advancement of the sun visor main body 10 in accordance with the incident angle θ of the incident light, and the light blocking control is performed through a simple computation process.

(12) Each.occupant can easily adjust the assumed position 62 to the occupant's eye position P by manipulating the cross key 64b. Therefore, the controller 41 performs the light blocking control appropriate for the individual occupant.

(13) Since the manipulation direction of the cross key 64b corresponds to the moving direction of the assumed position 62 the occupant can easily grasp the direction along which the assumed position 62 is moved. Therefore, the occupant can easily manipulate the cross key 64b and easily adjust the assumed position 62 to the occupant's eye position P.

The above embodiments may be modified as follows.

The amount of advancement of the sun visor main body 10 according to the above embodiments may be set in less than or equal to four stages or greater than or equal to six stages as a whole. If the amount of advancement of the sun visor main body 10 is set in less than or equal to four stages as a whole, the controller 41 easily performs the light blocking control. If the amount of advancement of the sun visor main body 10 is set in greater than or equal to six stages, the advancing motion and the retracting motion of the sun visor main body 10 becomes finer as compared to the first embodiment. Thus, the controller 41 performs the light blocking control that is more comfortable for the occupant.

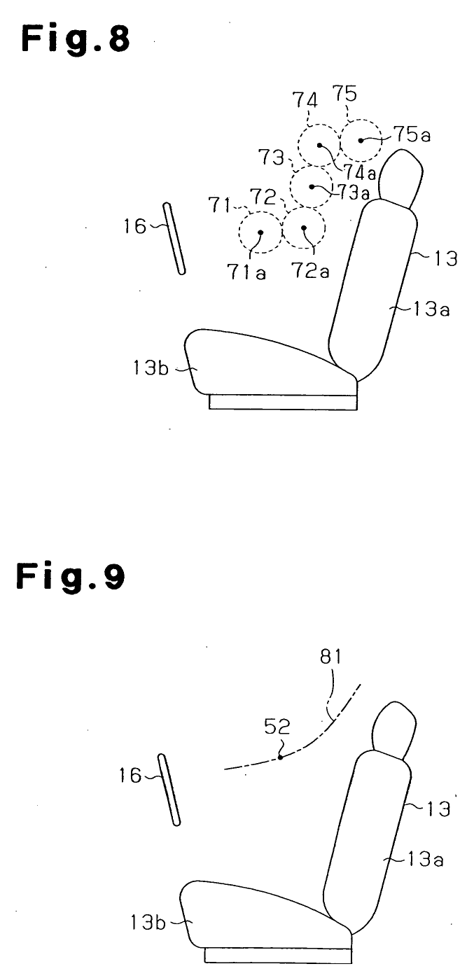

The select positions 21a to 25a of the first embodiment may be set along a curved line that is arcuate and bulges toward the occupant. Also, the select positions 21a to 25a may be changed to, as shown in FIG. 8, select positions 71a to 75a, which are located along a line that extends in the fore-and-aft direction of the vehicle 2 and has a step-like form in which the rear half is located upper than the front half. In this case, the select ranges 21 to 25 are changed to select ranges 71 to 75, which are configured by circles arranged adjacent to each other.

The number of the select positions of the first embodiment may be four or less, or six or more. If the number of the select positions is less than or equal to four, the controller 41 further easily performs the light blocking control. If the number of the select positions is greater than or equal to six, the controller 41 performs the light blocking control more appropriate for the individual occupant as compared to the first embodiment. The number of the switches of the manipulation device 7 is selectively increased and decreased corresponding to the increase or decrease of the select positions.

As shown in FIG. 9, the range 51 of the eye position P of the second embodiment may be changed to a range 81 of the eye position P located along a curved line that is arcuate and bulges toward the occupant. The rear end of the curved line is located upper than the front end.

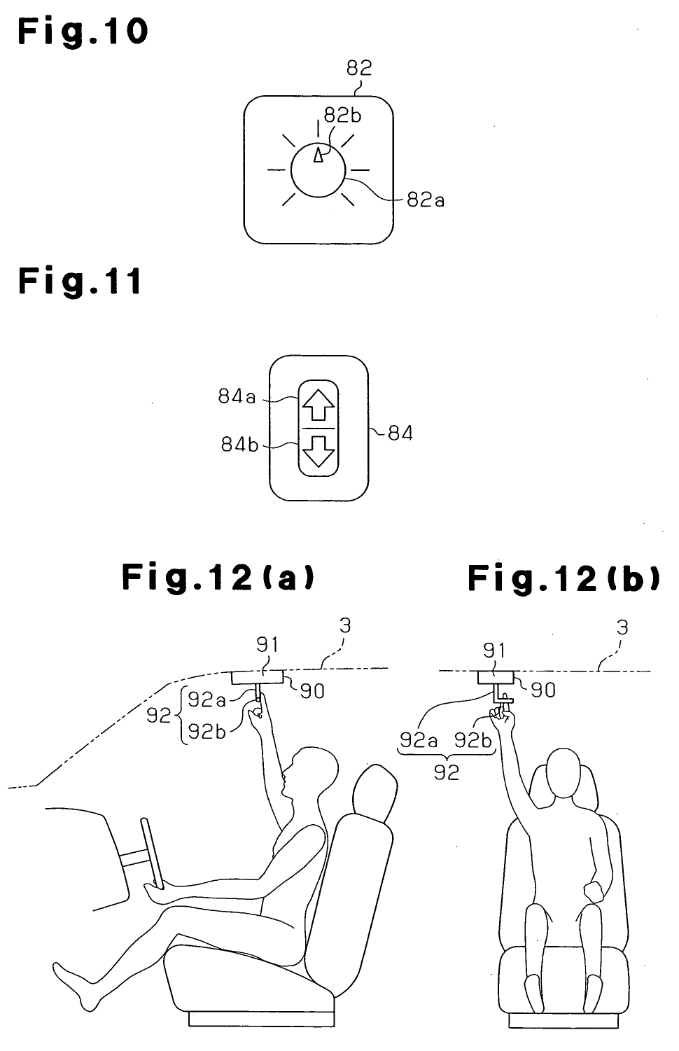

The manipulation device 54 of the second embodiment may be changed to a rotary manipulation device 82 as shown in FIG. 10. The manipulation device 82 includes a manipulation body, which is a columnar dial switch 82a. The assumed position 52 moves within the range 51 of the eye position P as the occupant rotates the dial switch 82a. A triangular mark 82b is provided on the surface of the dial switch 82a. The occupant grasps the rotational state of the dial switch 82a with the mark 82b. When the dial switch 82a is rotated counterclockwise to the maximum, the assumed position 52 is located at the lowermost position of the range 51 of the eye position P, and when. the dial switch 82a is rotated clockwise to the maximum, the assumed position 52 is located at the uppermost position of the range 51 of the eye position P. If the upper surface of the dial switch 82a is flush with the surface of the side box 15, a foreign object is prevented from being caught by the dial switch 82a, and the assumed position 52 is prevented from being moved when the assumed position 52 does not need to be moved.

Also, the manipulation device 54 may be changed to a switch-type manipulation device 84 as shown in FIG. 11. The manipulation device 84 includes a switch 84a, which moves the assumed position 52 upward, and a switch 84b, which moves the assumed position 52 downward, within the range 51 of the eye position P. The switches 84a, 84b configure the manipulation body.

Also, the manipulation device 54 may be changed to a manipulation device 90 shown in FIGS. 12(a) and 12(b). The manipulation device 90 includes a housing 91 and a manipulation body, which is a manipulation lever 92, and is secured to the ceiling 3 behind the opening portion 3a. The manipulation lever 92 is L-shaped, and consists of a support rod 92a and a manipulation rod 92b, which extends from the distal end of the support rod 92a in a direction perpendicular to the support rod 92a. The proximal end of the support rod 92a is supported in the housing 91, and the support rod 92a is designed to be tiltable in the forward direction and the rearward direction about the proximal end. The support rod 92a tilts forward when the occupant presses the manipulation rod 92b forward, and tilts rearward when the occupant presses the manipulation rod 92b rearward. Furthermore, when the manipulation rod 92b is not pressed by the occupant, the support rod 92a extends downward from the housing 91.

Two switch type sensors (not shown) are arranged in the housing 91 in the vicinity of the support rod 92a. One of the two sensors is switched on when the support rod 92a is tilted forward, and supplies the controller 41 with a forward tilt signal that indicates that the support rod 92a is tilted forward. On the other hand, the other sensor is switched on when the support rod 92a is tilted rearward, and supplies the controller 41 with a rearward tilt signal that indicates that the support rod 92a is tilted rearward. When the manipulation rod 92b is not pressed by the occupant, the two sensors are both switched off. The controller 41 moves the assumed position 52 within the range 51 of the eye position P in accordance with the forward tilt signal and the rearward tilt signal. For example, while the forward tilt signal is supplied to the controller 41, the controller 41 moves the assumed position 52 downward.

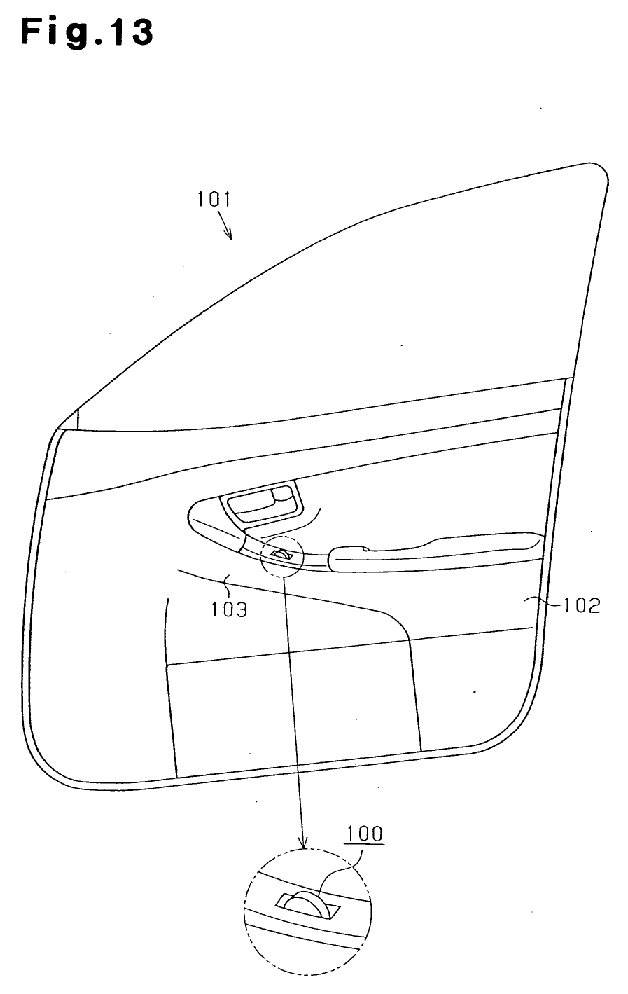

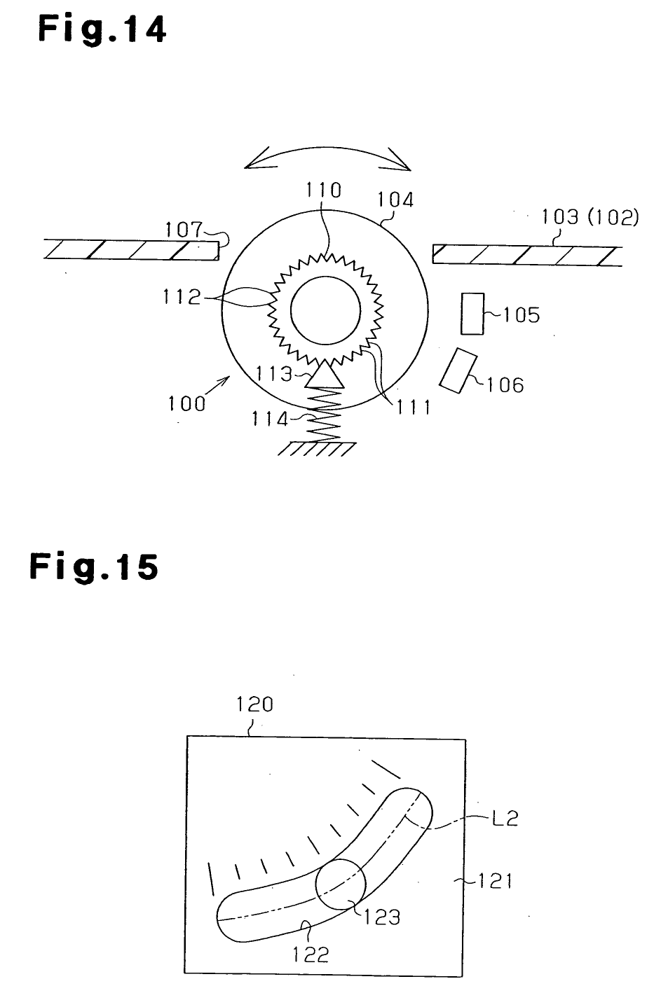

Furthermore, the manipulation device 54 may be changed to a manipulation device 100 provided on a door 101 adjacent to the side of the driver's seat as shown in FIGS. 13 and 14. A projection 103, which projects toward the inside of the vehicle 2, is formed on an inner panel 102, which configures the door 101. The manipulation device 100 is accommodated in the projection 103. The manipulation device 100 includes a rotary manipulation body 104, which is rotated by the occupant, and two rotation detection sensors 105, 106, which detect the rotation direction and the rotation amount of the rotary manipulation body 104.The rotary manipulation body 104 is formed into a disk-like shape and is supported in the manipulation device 100 to be rotatable about the central axis of the disk. Part of the rotary manipulation body 104 projects outward from a through hole 107 formed in the upper surface of the projection 103. The central axis of the rotary manipulation body 104 extends in the width direction of the vehicle. The rotation detection sensors 105, 106 are arranged adjacent to the rotary manipulation body 104 and are electrically connected to the controller 41. The rotation detection sensors 105, 106 output pulse signals to the controller 41 in accordance with the rotation of the rotary manipulation body 104. A predetermined phase difference is generated between the pulse signals of the rotation detection sensors 105, 106.

The controller 41 detects the rotation direction and the rotation amount of the rotary manipulation body 104 based on the pulse signal supplied from the rotation detection sensors 105, 106. Then, the controller 41 moves the assumed position 52 within the range 51 of the eye position P in accordance with the rotation direction and the rotation amount of the rotary manipulation body 104. For example, when the rotary manipulation body 104 is rotated clockwise as viewed from the driver's seat, the assumed position 52 moves upward within the range 51 of the eye position P. The moving amount of the assumed position 52 is set in accordance with the pulse signals output from the rotation detection sensors 105, 106. For example, the moving amount of the assumed position 52 is set for one pulse output from the rotation detection sensors 105, 106. Alternatively, the rotation speed of the rotary manipulation body 104 may be detected from the pulse signals output from the rotation detection sensors 105, 106, and the moving amount of the assumed position 52 per one pulse may be set in accordance with the rotation speed. In this case, the moving amount of the assumed position 52 per one pulse is set to be increased as, for example, the rotation speed becomes faster.

The manipulation device 100 includes a disk 110, which rotates integrally with the rotary manipulation body 104. Grooves 111, which extend in the thickness direction of the disk 110, are formed on the outer circumferential surface of the disk 110 at equal angular intervals. The grooves 111form gear portions 112. A triangular hook 113 is arranged outward of the disk 110. The hook 113 is urged toward the outer circumferential surface of the disk 110 by a coil spring 114, which configures an urging member, and is selectively engaged with one of the grooves 111. When the rotary manipulation body 104 is rotated, the disk 110 is rotated integrally with the rotary manipulation body 104. Thus, the groove 111 engaged with the hook 113 is switched to the adjacent groove 111 sequentially in accordance with the rotation of the disk 110. At this time, since the hook 113 is engaged with the adjacent groove 111 by moving over the gear portion 112, a small vibration is applied to the finger of the occupant manipulating the rotary manipulation body 104.

When the manipulation device 100 configured as described above is used, the assumed position 52 is easily moved by rotating the rotary manipulation body 104. Therefore, the occupant can adjust the position of the assumed position 52 by a small movement as compared to a case where the assumed position 52 is moved using the manipulation device 54. As a result, the operability of the manipulation device 100 is improved. Also, since a small vibration is applied to the finger of the occupant manipulating the rotary manipulation body 104 in accordance with the rotation of the rotary manipulation body 104, the occupant easily grasps that the rotary manipulation body 104 is rotated. The manipulation devices 82, 84, 90, 100 may be used in correspondence with the range 81 of the eye position P set along the curved line shown in FIG. 9.

The groove 54b of the second embodiment may be formed to extend along the range 51 of the eye position P.

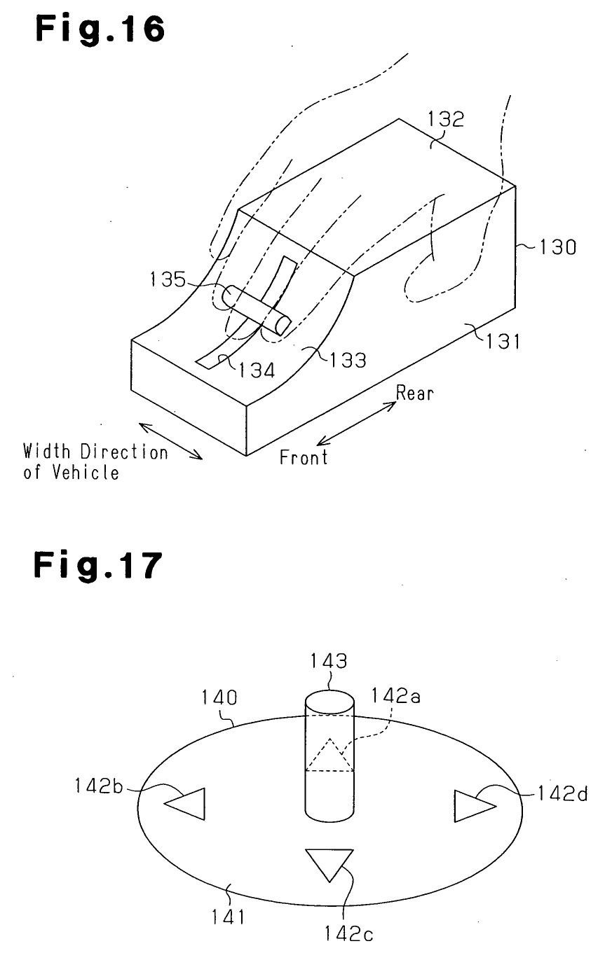

In a case where the range of the eye position P is the range 81 of the eye position P set along the curved line shown in FIG. 9, the manipulation device 54 may be changed to the manipulation device 120, 130 shown in FIGS. 15 and 16. The manipulation device 120 is secured to the side box 15 in the same manner as the manipulation device 54. As shown in FIG. 15, the manipulation device 120 includes a substantially square panel 121 and a manipulation body, which is a slide switch 123. A groove 122 is formed in the panel 121, and a slide switch 123 is arranged to be slidable along the longitudinal direction of the groove 122. The groove 122 is formed such that a curved line L2 that passes through the center of the width direction matches with the range 81 of the eye position P. Therefore, the slide switch 123 describes a path that is the same as the range 81 of the eye position P when slid in the groove 122.

The manipulation device 130 is secured to, for example, the upper surface of the projection 103 located on the inner panel 102 of the door 101 of driver's seat. As shown in FIG. 16, the manipulation device 130 includes a substantially rectangular solid base 131, and the longitudinal direction of the base 131 matches with the fore-and-aft direction of the vehicle 2. The width of the base 131 in the width direction of the vehicle is set to be substantially the same as the average value of the width of a palm of a hand of an adult. The upper surface of the base 131 is configured by a flat surface portion 132 and a manipulation surface 133, which is located in front of the flat surface portion 132. The shape of the manipulation surface 133 as viewed from the driver's seat is curved in the same manner as the range 81 of the eye position P. A groove 134 is formed in the manipulation surface 133 along the fore-and-aft direction of the vehicle 2. The manipulation device 130 includes a slide switch 135, which is guided by the groove 134 and is slidable along the longitudinal direction of the groove 134. When the slide switch 135 is slid, the slide switch 135 describes a path that is the same as that of the range 81 of the eye position P when viewed from the driver's seat. The manipulation device 130 is a variable resistor, and the resistance value of the variable resistor increases as, for example, the slide switch 135 is moved rearward. Therefore, the controller 41 detects the assumed position 52 within the range 81 of the eye position P by detecting.the voltage corresponding to the resistance value that is changed as the slide switch 135 is slid.

When the above mentioned manipulation device 120, 130 is used, the occupant easily grasps the assumed position 52 within the range 81 of the eye position P. Therefore, the assumed position 52 can be moved to a position closer to the eye position P of the occupant. Thus, the controller 41 can perform a more appropriate light blocking control. Also, since the width of the base 131 in the width direction of the vehicle is substantially the same as the average value of the width of the palm of the hand of the adult, the occupant can easily manipulate the slide switch 135 by putting the palm of the hand on the flat surface portion 132 of the base 131. The manipulation device 130 may be arranged at a position other than the projection 103 of the inner panel 102.

The controller 41 of the second embodiment may divide the range 51 of the eye position P into a number of sections, and include a control map for each section. In this case, the controller 41 performs the light blocking control corresponding to the incident angle θ of the incident light based on the control map corresponding to the section including the moved assumed position 52. Similarly, the controller 41 of the third embodiment may divide the range 61 of the eye position P into a number of sections, and include a control map for each section. In this case, the controller 41 performs the light blocking control corresponding to the incident angle θ of the incident light based on the control map corresponding to the section including the moved assumed position 62. With this configuration, a procedure for calculating the amount of advancement of the sun visor main body 10 by the controller 41 is simplified, thereby reducing the load on the controller 41.

The manipulation device 64 of the third embodiment may be changed to a manipulation device 140 shown in FIG. 17. The manipulation device 140 includes a circular plate 141 and a manipulation body, which is a manipulation stick 143. Triangular marks 142a to 142d, which indicate the vertical direction and the fore-and-aft direction, are located on the surface of the plate 141. The manipulation stick 143 is located at the center of the plate 141, and is designed to be tiltable in any direction using the proximal end of the manipulation stick 143 as a fulcrum. Such a manipulation device 140 is arranged such that the inclination direction of the manipulation stick 143 corresponds to the moving direction of the assumed position 62.

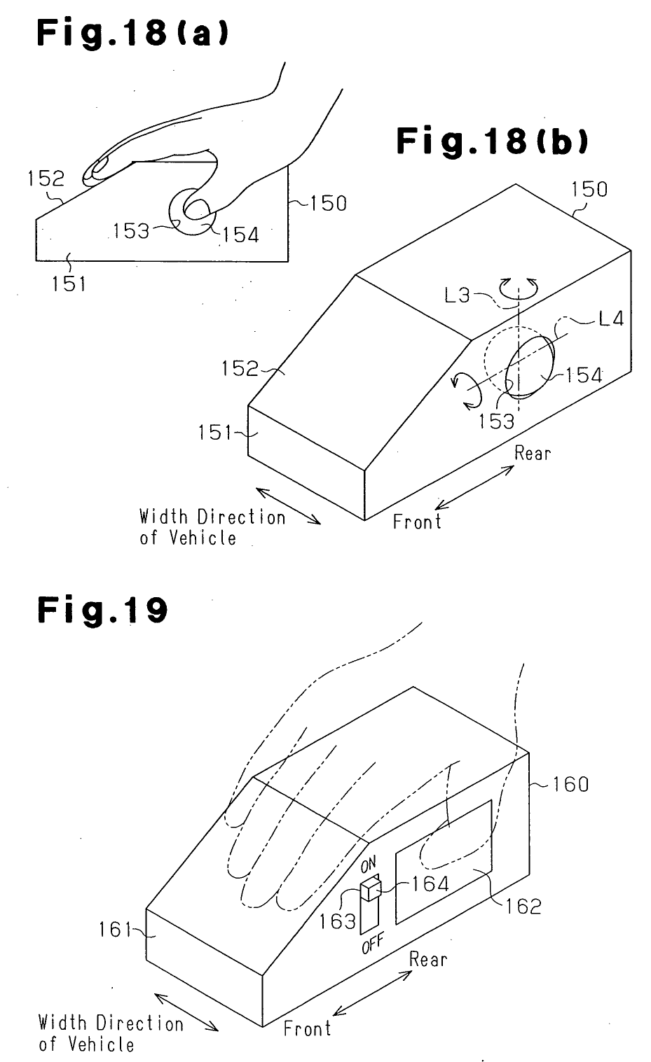

Also, the manipulation device 64 may be changed to a manipulation device 150 shown in FIGS. 18(a) and 18(b). Like the manipulation device 130, the manipulation device 150 is arranged on the upper surface of the projection 103 located on the inner panel 102 of the door adjacent to the side of the driver's seat. The manipulation device 150includes a substantially rectangular solid base 151. The width of the base 151 in the width direction of the vehicle is substantially the same as the average value of the width of the palm of the hand of the adult. An inclined surface 152, which inclines downward toward the front edge, is formed on the front half of the upper surface of the base 151. A manipulation bore 153 is formed at the center of the side surface of the base 151 adjacent to the driver's seat. A ball 154 is arranged in the base 151, and part of the ball 154 projects outward from the manipulation bore 153. The ball 154 is supported to be rotatable about the center of the ball 154.

Two rotation detection sensors (not shown) are arranged inside the base 151. One of the two rotation detection sensors outputs, to the controller 41, a pulse signal corresponding to the rotation direction and the rotation amount of the ball 154, which rotates about a rotation axis, or a straight line L3 that passes through the center of the ball 154 and extends in the vertical direction as a. Also, the other rotation detection sensor outputs, to the controller 41, a pulse signal corresponding to the rotation direction and the rotation amount of the ball 154, which rotates about a rotation axis, or a straight line L4 that passes through the center of the ball 154 and extends in the fore-and-aft direction of the vehicle 2 as a. The controller 41 detects the rotation direction and the rotation amount of the ball 154 based on the pulse signals supplied from both the rotation detection sensors. Then, the controller 41 detects the assumed position 62 within the range 61 of the eye position P in accordance with the rotation direction and the rotation amount of the ball 154. As in the case with the manipulation device 100, the moving amount of the assumed position 62 is set in accordance with the pulse signals output from the rotation detection sensors.

Also, the manipulation device 64 may be changed to a manipulation device 160 as shown in FIG. 19. The manipulation device 160 includes a base 161 that is the same as the manipulation device 150. A rectangular touch pad 162 is arranged on the side surface of the base 161. adjacent to the driver's seat. When the occupant drags a finger across the touch pad 162, the capacitance of part of the touch pad 162 touched by the occupant's finger changes. The controller 41 detects in which direction the occupant has dragged the finger on the touch pad 162 and the distance along which the occupant has dragged the finger based on the change of the capacitance. In accordance with the detection result, the controller 41 detects the assumed position 62 within the range 61 of the eye position P. The touch pad 162 is not limited to have the configuration in which the position where the finger of the occupant touched and the direction and the distance along which the finger moved are detected by detecting the change of the capacitance. For example, the touch pad 162 may be designed to detect the position where the finger of the occupant touched and the direction and the distance along which the finger moved by using the pressure applied when the occupant touches the touch pad 162. In this case, the controller 41 detects the change of the resistance value at a portion of the touch pad 162 where the pressure is applied by the change of the voltage.

A switch 163 for selecting whether to actuate the touch pad 162 is arranged on the side surface of the base 161 adjacent to the driver's seat in front of the touch pad 162. The switch 163 is switched on when the occupant adjusts the assumed position 62, and is switched off when the occupant does not adjust the assumed position 62. For example, as shown in FIG. 19, when a knob 164 of the switch 163 is moved upward, the switch 163 is on, and the change of the capacitance on the touch pad 162 is detected. On the other hand, when the knob 164 is moved downward, the switch 163 is off, and the change of the capacitance on the touch pad 162 is not detected. Providing the switch 163 prevents the assumed position 62 from being moved due to a foreign object touching the touch pad 162 when the assumed position 62 does not need to be moved.

By using the manipulation device 150, 160 instead of the manipulation device 64, the assumed position 62 is moved by only rotating the ball 154 according to the manipulation device 150, and the assumed position 62 is moved by only dragging a finger across the touch pad 162 according to the manipulation device 160. That is, the occupant can adjust the assumed position 62 by a small movement as compared to a case where the manipulation device 64 is used. Thus, the operability of the manipulation device 150, 160 is improved. Also, since the inclined surface is formed at the front portion of the upper surface of the base 151 and the base 161, the occupant can easily put the hand on the base 151, 161. As a result, the operability of the manipulation device 150, 160 is improved. The manipulation device 150, 160 may be arranged at a position other than the projection 103 of the inner panel 102.

When the assumed position 62 of the third embodiment is stored in the nonvolatile storage device 42, the position of the steering wheel 16, the position of the seat 13,and the reclining position of the seat back 13a may be stored in the nonvolatile storage device 42. In this case, the controller 41 specifies the occupant from the position of the steering wheel 16, the position of the seat 13, and the reclining position of the seat back 13a, and reads the assumed position 62 corresponding to the occupant. Therefore, even if the occupant is changed, the assumed position 62 does not need to be set each time.

The shape of the range 61 of the eye position P according to the third embodiment may be changed to a polygonal shape such as a triangular shape, a circular shape, and an oval shape.

The manipulation device 7, 54, 64, 82, 84, 120, 140 may be secured to a dashboard, the ceiling 3 above the seat 13, or on part of the door adjacent to the side of the driver's seat other than the side box 15, or may be designed to be remote controlled without being secured in the vehicle 2.

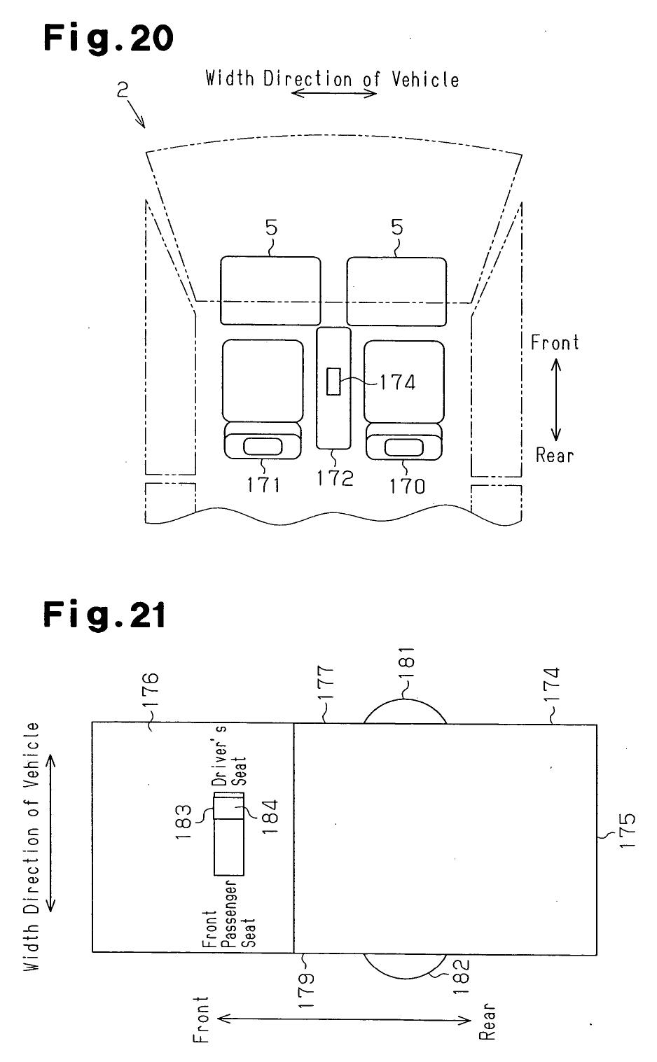

The vehicle sun visor apparatus 1 of the above embodiments may be provided for only the occupant seated in the front passenger seat, or for both the occupants seated in the driver's seat and the front passenger seat. For example, as shown in FIG. 20, the light blocking device 5 may be provided for both the occupants seated in the driver's seat 170 and the front passenger seat 171. A manipulation device 174 may be arranged on a center console 172 located between the driver's seat 170 and the front passenger seat 171. As shown in FIG. 21, the manipulation device 174 includes a base 175 that is the same as the base 151. The width of the base 175 in the width direction of the vehicle is set to be substantially the same as the average value of the width of the palm of the hand of the adult. An inclined surface 176, which is inclined downward toward the front edge, is formed on the front end portion of the upper surface of the base 175. A manipulation bore (not shown) is formed at the center of a side face 177 of the base 175 adjacent to the driver's seat, and a ball 181 is arranged in the base 175 such that part of the ball 181 projects outward from the manipulation bore. Likewise, a manipulation bore (not shown) is formed at the center of a side face 179 of the base 175 adjacent to the front passenger seat, and a ball 182 is arranged in the base 175 such that part of the ball 182 projects outward from the manipulation bore. The balls 181, 182 are supported in the base 151 to be rotatable about the center of the ball 181, 182. Two rotation detection sensors (not shown) are arranged for each ball 181, 182 inside the base 175. When the balls 181, 182 are rotated, the pulse signals corresponding to the rotation direction and the rotation amount are output from the rotation detection sensors to the controller 41 in the same manner as when the ball 154 is rotated. The controller 41 detects the rotation direction and the rotation amount of the balls 181, 182 based on the pulse signals output from the rotation detection sensors. Then, the controller 41 detects the assumed position 62 within the range 61 of the eye position P in accordance with the rotation direction and the rotation amount of the balls 181, 182. Manipulating the ball 181 facing the driver's seat 170 moves the assumed position 62 for controlling the movement of the sun visor main body 10 provided for the occupant seated in the driver's seat 170. Also, manipulating the ball 182 facing the front passenger seat 171 moves the assumed position 62 for controlling the movement of the sun visor main body 10 provided for the occupant seated in the front passenger seat 171.

The manipulation device 174 includes a switch 183. In the manipulation device 174, the switch 183 switches between the movement of the assumed position 62 for performing the light blocking control for the occupant seated in the driver's seat 170 and the movement of the assumed position 62 for performing the light blocking control for the occupant seated in the front passenger seat 171. A knob 184 of the switch 183 is located on the inclined surface 176 of the base 175. When the knob 184 is moved toward the driver's seat 170, operation of the ball 181 becomes available, and when the knob 184 is moved toward the front passenger seat 171, operation of the ball 182 becomes available. Therefore, the single manipulation device 174 can move the assumed position 62 corresponding to the occupant seated in the driver's seat 170 and the occupant seated in the front passenger seat 171.

According to the manipulation device 174, a single ball may be arranged on the upper surface of the base 175 instead of the two balls 181, 182. The assumed position 62 for the occupant seated in the driver's seat 170 and the occupant seated in the front passenger seat 171 may be adjusted by the single ball. Alternatively, two touch pads or a single touch pad may be arranged on the base 175 instead of the two balls 181, 182. The assumed position 62 corresponding to the occupant seated in the driver's seat 170 and the occupant seated in the front passenger seat 171 may be adjusted by these touch panels.

In the above embodiments, the vehicle sun visor apparatus 1 may include a display. The display shows the select positions 21a to 25a, 71a to 75a and the assumed positions 52, 62. The occupant adjusts the position of the assumed position while looking at the display. In this case, the occupant can easily adjust the assumed position to the occupant's eye position P. As described above, in a case where the vehicle sun visor apparatus 1 includes the display, the manipulation device may include a manipulation body, which is a-three-dimensional mouse, a pen-type pointing device, or the like.

Also, the display of the vehicle sun visor apparatus 1 may be a display that also serves as a touch panel (manipulation device). In this case, an image of the occupant shot from the width direction of the vehicle is displayed on the display, and for example, the range 61 of the eye position P may be displayed on the display in a state where the range 61 is overlapped with the image of the occupant. Then, when a finger or the like of the occupant touches a desired position within the range 61 of the eye position P displayed on the display, the assumed position 62 moves to the touched position.

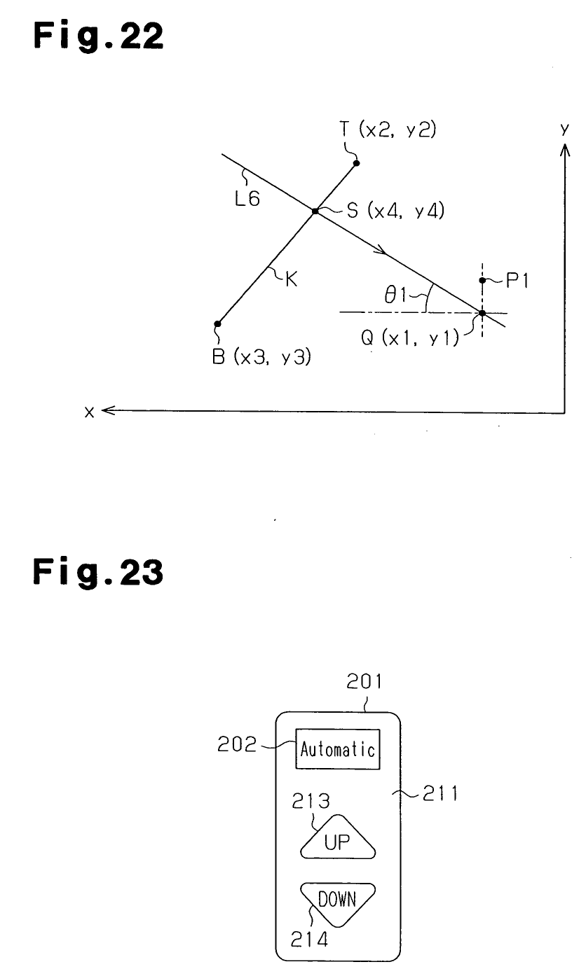

The controller 41 of the above embodiments may perform the light blocking control without using the control map. In this case, the controller 41 performs the light blocking control using a light blocking position Q, which is shifted downward from the assumed position specified among the select positions 21a to 25a and 71a to 75a and the assumed position 52, 62 by an amount corresponding to the light blocking amount required for preventing dazzlement of the occupant (see FIG. 4). The light blocking position Q is set as the lowermost point of the range in which the sun visor main body 10 blocks light. FIG. 22 shows an arbitrary xy-coordinate plane including an x-axis representing the fore-and-aft direction and a y-axis representing the vertical direction. In the xy-coordinate plane, P1 represents the assumed position set by the occupant, and the coordinate values (x1, y1) represents the light blocking position Q set in accordance with the assumed position P1. The assumed position P1 corresponds to the assumed position specified among the select positions 21a to 25a and 71a to 75a of the above embodiments, and the assumed positions 52, 62. The coordinate values (x2, y2) represents the distal end position T of the completely retracted sun visor main body 10, and the coordinate values (x3, y3) represents the distal end position B of the completely advanced sun visor main body 10. Furthermore, the coordinate values (x4, y4) represents the distal end position S of the sun visor main body 10 that is advanced to a position where the amount of advancement is optimal for the occupant when the incident light having the incident angle θ1 enters the measuring area A.

When the path described by the distal end of the sun visor main body 10 is a straight line, the position S is considered to be the intersection between a straight line K, which shows the path of the distal end position of the sun visor main body 10, and a straight line L6, which passes through the light blocking position Q and is inclined by the same angle as the incident angle θ1 of the incident light. Thus, the straight line K showing the path of the distal end position of the sun visor main body 10 is represented by the following equation (1) based on the coordinate values of the positions T, B, S.

$$y4 - y2 = \frac{y3 - y2}{x3 - x2} ( x4 - x2 ) \qquad ( 1 )$$

Also, the straight line L6, which passes through the light blocking position Q and is inclined by the same angle as the incident angle θ1 of the incident light is represented by the following equation (2) based on the light blocking position Q, and the coordinate values of the position S.
y4−y1=(x4−x1)tan θ1 (2)

Based on these equations (1), (2), the coordinate values (x4, y4) of the position S is obtained using the following equations (3), (4).

$$\begin{matrix}x4 = \frac{( x3 - x2 ) ( y2 - y1 + x1 \cdot tan θ 1 ) - ( y3 - y2 ) x2}{( x3 - x2 ) \cdot tan θ 1 - ( y3 - y2 )} & ( 3 ) \\ y4 = \frac{y3 - y2}{x3 - x2} \{ \frac{\begin{matrix}( x3 - x2 ) ( y2 - y1 + x1 \cdot tan θ 1 ) - \\ ( y3 - y2 ) x2\end{matrix}}{( x3 - x2 ) \cdot tan θ 1 - ( y3 - y2 )} x2 \} + y2 & ( 4 )\end{matrix}$$

Therefore, the coordinate values (x4, y4) of the position S is calculated using the equations (3), (4) when the variables, which are the incident angle θ1 of the incident light and the coordinate values (x1, y1) of the light blocking position Q set based on the assumed position P1, are determined.

Based on the assumed position P1, the controller 41 obtains the light blocking position Q, which is shifted downward from the assumed position P1 by a distance corresponding to the light blocking amount required by the occupant, and calculates the coordinate values (x4, y4) of the position S in accordance with the coordinate values (x1, y1) of the light blocking position Q and the incident angle θ1 of the incident light. Then, the controller 41 performs the light blocking control such that the distal end of the sun visor main body 10 is located at a position of the coordinate values (x4, y4) of the position S. The light blocking amount required by the occupant is referred to as the light blocking amount required by, for example, an average sized occupant and is stored in the nonvolatile storage device 42 in advance. The light blocking amount required by the average sized occupant is obtained through experiments. When calculating the light blocking position Q, the controller 41 determines a position shifted downward from the assumed position P1 by an amount corresponding to the light blocking amount stored in the nonvolatile storage device 42 as the light blocking position Q. The light blocking amount required by the occupant may be arbitrarily set for the individual occupant.

In this case, a slight change of the incident angle θ1 and a slight change of the assumed position P1 are reflected in the amount of advancement of the sun visor main body 10. Therefore, the controller 41 more reliably performs the light blocking control in accordance with the assumed position P1. Since the amount of advancement of the sun visor main body 10 is not controlled step-by-step using the control map as in the above embodiments, the sun visor main body 10 is prevented from being advanced by an amount that is more than necessary. As a result, the occupant obtains a wider view as compared to the above embodiments while light is blocked by the sun visor main body 10.

In the example described with reference to FIG. 22, the path of the distal end position of the sun visor main body 10 is represented by the straight line K. However, the controller 41 can perform the light blocking control in the same manner even if the distal end position of the sun visor main body 10 describes a curved path. That is, the curved line of a path described by the distal end of the sun visor main body 10 is obtained using the coordinate values of the positions T, B, S. Then, the controller 41 obtains the intersection between the curved line and the straight line L6, which passes through the light blocking position Q and is inclined by the same angle as the incident angle θ1 of the incident light, and performs the light blocking control such that the distal end of the sun visor main body 10 is arranged at a position of the intersection.

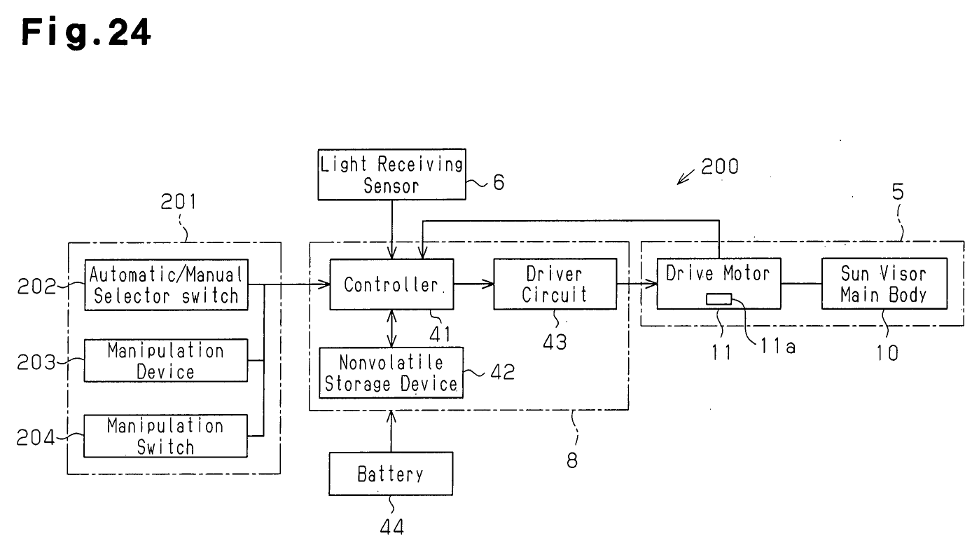

The vehicle sun visor apparatus 1 may be designed to adjust the position of the sun visor main body 10 in either of a manual mode for adjusting the position of the sun visor main body 10 in accordance with a signal from a manual manipulation switch or an automatic mode for adjusting the position of the sun visor main body 10 in accordance with the assumed position. For example, a vehicle sun visor apparatus 200 shown in FIG. 24 has a manipulation input device 201, and the manipulation device 201 includes an automatic/manual selector switch 202, a manipulation device 203, and a manipulation switch 204, which forms a manual manipulation switch.

The automatic/manual selector switch 202 selects in which of the manual mode and the automatic mode the adjustment of the position of the sun visor main body 10 is performed. The automatic/manual selector switch 202 is electrically connected to the controller 41, and outputs an on/off signal to the controller 41 when manipulated by the occupant. When the on signal is supplied from the automatic/manual selector switch 202, the controller 41 adjusts the position of the sun visor main body 10 in the automatic mode. On the other hand, when the off signal is supplied from the automatic/manual selector switch 202, the controller 41 adjusts the position of the sun visor main body 10 in the manual mode.

The manipulation device 203 is electrically connected to the controller 41. Like the manipulation devices 7, 54, 64, 82, 84, 90, 100, 120, 130, 140, 150, 160, 174, the manipulation device 203 moves the assumed position specified from the select positions 21a to 25a and 71a to 75a, and the assumed position 52, 62.

The manipulation switch 204 is for the occupant to manually adjust the amount of advancement of the sun visor main body 10. The manipulation switch 204 is electrically connected to the controller 41, and outputs a signal for advancing or retracting the sun visor main body 10 to the control device 8 when the occupant manipulates the manipulation switch 204. Upon receipt of the signal, the controller 41 advances or retracts the sun visor main body 10 in accordance with the signal.

In this case, the occupant can select whether the adjustment of the position of the sun visor main body 10 is performed by the occupant or the control device 8 (the controller 41) by manipulating the automatic/manual selector switch 202. Therefore, the vehicle sun visor apparatus 200 can adjust the position of the sun visor main body 10 in accordance with the preference of both the occupant who does not require the adjustment of the position of the sun visor main body 10 by the control device 8 (the occupant who wears sunglasses, or the like) and the occupant who requires the adjustment of the position of the sun visor main body 10 by the control device 8. Then, for example, when the occupant does not want to change the position of the sun visor main body 10 in accordance with the incident angle θ of the incident light, the occupant selects the manual mode to stop the movement of the sun visor main body 10. Also, by manipulating the manipulation switch 204, the occupant can make the sun visor main body 10 to have an arbitrary amount of advancement that the occupant intends.

The manipulation input device 201 is secured to the side box 15 or the inner panel 102 of the door 101 of the driver's seat. The manipulation input device 201 includes a substantially rectangular panel 211 as shown in FIG. 23. The automatic/manual selector switch 202 and the manipulation bodies, which are manipulation switches 213, 214, are located on the panel 211.

The manipulation switches 213, 214 are manipulated by the occupant to move the assumed position 52 in the range 51 of the eye position P shown in FIG. 6(a) or the range 81 of the eye position P shown in FIG. 9, or when advancing or retracting the sun visor main body 10 manually. The manipulation switches 213, 214 are electrically connected to the controller 41. The manipulation switches 213, 214 function as the manipulation device 203 when the on signal is output from the automatic/manual selector switch 202. That is, the controller 41 recognizes the signals supplied from the manipulation switches 213, 214 as the manipulation signal for moving the assumed position 52. On the other hand, the manipulation switches 213, 214 function as the manipulation switch 204 when the off signal is output from the automatic/manual selector switch 202. That is, the controller 41 recognizes the signals supplied from the manipulation switches 213, 214 as the signal for advancing or retracting the sun visor main body 10.

In this case, the occupant can move the assumed position 52 by the manipulation switches 213, 214, and adjust the amount of advancement of the sun visor main body 10. Therefore, the number of components of the vehicle sun visor apparatus 1 is reduced as compared to a case where, the switch for moving the assumed position 52 (manipulation device 203) and the switch for advancing or retracting the sun visor main body 10 (manipulation switch 204) are provided. Accordingly, the manufacturing cost of the vehicle sun visor apparatus 1 is reduced.

The manipulation input device is not limited to have the configuration of the manipulation input device 201 shown in FIG. 23, but the manipulation device 203 and the manipulation switch 204 may be provided separately. In this case, the manipulation device 203 may move the assumed position 52 within the range 51, 81 of the eye position P, or the assumed position 62 within the range 61 of the eye position P. Also, the manipulation device 203 may select the select positions 21a to 25a.

As long as the incident angle θ of the incident light is detectable and the light receiving sensor 6 does not block the view of the occupant, the light receiving sensor 6 of the above embodiments may be secured to a dashboard, a front pillar, or a rearview mirror 14 in the vehicle 2. Alternatively, the light receiving sensor 6 may be secured to the outside of the vehicle 2 such as on a side mirror.

1. A vehicle sun visor apparatus for blocking incident light on an eye position of an occupant of a vehicle, the apparatus comprising:
a sun visor main body, which is movably supported by the vehicle to block the incident light;
a drive device for moving the sun visor main body;
a light receiving sensor located at a position that does not block the view of the occupant, and the light receiving sensor outputs a signal in accordance with the incident light;
a manipulation device, wherein a range of an assumable eye position in the vehicle is set in advance, and the manipulation device inputs an assumed position of the eye position within the range by manipulation performed by the occupant; and
a control device, which specifies the incident angle of the incident light based on the output from the light receiving sensor, and the control device controls the movement of the sun visor main body by the drive device based on the incident angle and the assumed position.

2. The apparatus according to claim 1, wherein the manipulation device includes a manipulation body manipulated by the occupant,
wherein the control device sets a plurality of select positions corresponding to eye positions of a plurality of occupants having different physical sizes, and
wherein, when the occupant manipulates the manipulation body, the manipulation device specifies the assumed position among the select positions.

3. The apparatus according to claim 2, wherein the select positions are set along a straight line, which inclines upward from the front of the vehicle to the rear of the vehicle.

4. The apparatus according to claim 1, wherein the manipulation device includes a manipulation body manipulated by the occupant, and
wherein, when the occupant manipulates the manipulation body, the manipulation device moves the assumed position in the vertical and fore-and-aft directions of the vehicle.

5. The apparatus according to claim 4, wherein the vehicle includes a seat in which the occupant is seated and a door located adjacent to the seat, and the manipulation device is located on the door.

6. The apparatus according to claim 4, wherein the manipulation direction of the manipulation body corresponds to the moving direction of the assumed position.

7. The apparatus according to claim 1, wherein the range of the eye position is set along a straight line.

8. The apparatus according to claim 7, wherein the range of the eye position is set along a straight line, which inclines upward from the front of the vehicle to the rear of the vehicle.

9. The apparatus according to claim 1, wherein the manipulation device includes a rotary manipulation body, which is rotatably supported about an axis, and when the occupant manipulates the rotary manipulation body, the assumed position is moved in accordance with the rotation direction and the rotation amount of the rotary manipulation body.

10. The apparatus according to claim 9, wherein the manipulation device includes:
a disk, which rotates integrally with the rotary manipulation body, wherein a plurality of grooves, which extend along the thickness direction of the disk, are formed on a circumferential surface of the disk;
a hook, which selectively engages with each groove; and an urging member, which urges the hook toward the groove, wherein the groove engaged with the hook is sequentially switched to the adjacent groove in accordance with rotation of the rotary manipulation body.

11. The apparatus according to claim 1, wherein the manipulation device includes a ball, and the ball is supported to be rotatable about the center of the ball, and
wherein, when the occupant manipulates the ball, the manipulation device moves the assumed position in accordance with the rotation direction and the rotation amount of the ball.

12. The apparatus according to claim 1, wherein the manipulation device includes a touch pad, and the manipulation device moves the assumed position in accordance with a position on the touch pad where the occupant touches and a change of the touched position.

13. The apparatus according to claim 7, wherein the manipulation device includes a manipulation body manipulated by the occupant,
wherein the manipulation body is moved to describe a path that is the same as the range of the eye position, and
wherein, when the occupant manipulates the manipulation body, the manipulation device moves the assumed position in accordance with the moving amount of the manipulation body.

14. The apparatus according to claim 1, wherein the control device sets a line representing the path of the distal end position of the sun visor main body, a light blocking position, which is shifted downward from the assumed position by a predetermined distance set in accordance with the light blocking amount required by the occupant, and a straight line, which passes through the light blocking position and is inclined by the same angle as the incident angle of the incident light, and
wherein the sun visor main body is moved such that the distal end of the sun visor main body is located at the intersection between the line representing the path and the straight line.

15. The apparatus according to claim 1, comprising an automatic mode for adjusting the position of the sun visor main body in accordance with the assumed position of the eye position, a manual mode for adjusting the position of the sun visor main body in accordance with a signal from a manual manipulation switch, and a selector switch for selecting one of the automatic mode and the manual mode, and
wherein the control device controls the movement of the sun visor main body based on the assumed position when the automatic mode is selected, and controls the movement of the sun visor main body in accordance with the signal from the manual manipulation switch when the manual mode is selected.

16. The apparatus according to claim 1, comprising a nonvolatile storage device, which stores the assumed position,
wherein the control device controls the movement of the sun visor main body based on the assumed position stored in the nonvolatile storage device.

17. The apparatus according to claim 16, wherein the vehicle includes a steering wheel and a seat having a reclining seat back,
wherein the nonvolatile storage device stores the position of the steering wheel, the position of the seat, and the reclining position of the seat back, and
the control device controls the movement of the sun visor main body based on the assumed position, the position of the steering wheel, the position of the seat, and the reclining position of the seat back, which are stored in the nonvolatile storage device.

18. A vehicle sun visor apparatus for blocking incident light on an eye position of an occupant of a vehicle,
wherein the vehicle includes:
a driver's seat and a front passenger seat,
the apparatus comprising:
a first sun visor main body movably supported by the vehicle to block the incident light on the eye position of the occupant seated in the driver's seat;
a second sun visor main body movably supported by the vehicle to block the incident light on the eye position of the occupant seated in the front passenger seat;
a first drive device for moving the first sun visor main body;
a second drive device for moving the second sun visor main body;
a light receiving sensor located at a position that does not block the view of the occupant, and the light receiving sensor outputs a signal in accordance with the incident light;
a manipulation device, a range of an assumable eye position in the vehicle is set in advance, and the manipulation device inputs a first assumed position of the eye position of the occupant seated in the driver's seat and a second assumed position of the eye position of the occupant seated in the front passenger seat within the range by manipulation performed by the occupant; and
a control device, which specifies the incident angle of the incident light based on the output from the light receiving sensor, and the control device controls the movement of the first and the second sun visor main bodies by the drive devices based on the incident angle and the first and second assumed positions,
wherein the manipulation device includes:
a manipulation body manipulated by the occupant; and
a selector switch for selecting either the movement of the first assumed position or the movement of the second assumed position, and the manipulation device is located between the driver's seat and the front passenger seat.
